(19) United States
(12) Patent Application Publication
(10) Pub. No.: US 2007/0130829 A1
(43) Pub. Date: Jun. 14, 2007

(54) Decorative waterfall with planter

(76) Inventor: Philip Scott Barnhill, Lexington, KY (US)

Correspondence Address: Michael Coblenz, 752 Rose Hurst Way, Lexington, KY, 40515, US

(21) Appl. No.: 11/638,258

(22) Filed: Dec. 13, 2006

Related U.S. Application Data
(63) Continuation-in-part of application No. 11/521,894, filed on Sep. 15, 2006.
(60) Provisional application No. 60/749,898, filed on Dec. 14, 2005.

(51) Int. Cl. B05B 17/08; A01G 9/02

(52) U.S. Cl. 47/66.6; 239/23; 47/39

(57) ABSTRACT

A decorative waterfall containing an integrated planter is disclosed. The decorative waterfall contains a planter integrated within the main body of the waterfall and is constructed of natural or man made stone to create the appearance of a miniature natural waterfall.

### CROSS REFERENCE TO RELATED APPLICATIONS

This application is a continuation-in-part of U.S. patent application Ser. No. 11/521,894 filed Sep. 15, 2006, and also claims priority to U.S. provisional application Ser. No. 60/749,898, filed on Dec. 14, 2005 and incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to a decorative waterfall incorporating an integrated planter.

2. Description of the Related Art

There are many decorative fountains and waterfalls known in the art. Many are large and used as outdoor decoration and water features, and many others are smaller and used as indoor decorations. In general, the larger outdoor fountains are frequently made of natural materials such as stone, while the indoor waterfalls, due to their size, are generally made of non-natural materials.

Examples of small decorative indoor waterfalls include U.S. Pat. No. 5,167,368 to Nash, which discloses a decorative waterfall with an internal pumping mechanism which delivers water to an upper reservoir, and the water flows down a flat wall. In one embodiment the wall has numerous recesses which help to create the sound of flowing water. U.S. Pat. No. 5,571,409 to Scarborough, discloses a small waterfall for use with an aquarium. In one embodiment of the invention the water flows down a small wall molded from thermoplastic to simulate a rock-like wall. U.S. Pat. No. 5,732,656 to Tran, discloses a small waterfall for aquariums. The waterfall, which is designed for use inside the aquarium, and therefore under the water, uses sand rather than water and is made from small natural or ceramic stone. U.S. Pat. No. 6,149,070 to Hones, discloses a small decorative waterfall. The primary feature of the waterfall is that it provides a substantially continuous film of water or liquid flowing over a lip which creates a small wall of water. U.S. Pat. No. 6,290,144 to Maxwell discloses a small decorative waterfall having a circular conduit for water to flow around a central post. It also has a number of posts that extend outward from the conduit to allow some water to trickle out from the conduit. Finally, U.S. Pat. No. 6,382,520 to Hones, which is a continuation-in-part of the '070 patent also to Hones, discloses a small decorative waterfall that is designed to create a continuous unbroken wall of water.

The preceding prior art waterfalls are all artistic, decorative, and in many cases provide the soothing sound of flowing water. But none has the appearance of a simulated miniature natural waterfall. Additionally, none incorporates an integrated planter for holding living plants. There is a need, therefore, for a freestanding miniature natural waterfall with an integrated planter.

### BRIEF SUMMARY OF THE INVENTION

It is an object of the invention to provide a small decorative fountain and waterfall. It is a further object of the invention to provide an indoor water feature with the appearance of a natural waterfall. This is accomplished by constructing a small waterfall out of natural stone. In a preferred embodiment the stone will be small relatively flat blocks placed in a substantially horizontal configuration giving the appearance of a small natural waterfall.

In the preferred embodiment of the present invention the stones are natural, made from such stone material as limestone, slate, sandstone, marble, granite, or other suitable stone material. In alternate embodiments the stone blocks can be constructed from man-made materials such as concrete, ceramic, or plastics.

In one embodiment of the invention water flows down one wall of the waterfall, but in other embodiments of the invention, water can flow down any or all sides or exterior faces of the waterfall.

It is a further object of the invention to provide decorative features within the waterfall. To that end, indicia can be constructed into the waterfall. This can be accomplished by providing stone of a different color, and integrating that within the stonework of the waterfall. For example if the primary stone of the waterfall is limestone, which generally has light to medium grey coloration, alternate stone in different colors can be used. For example granite with a pink or red hue can be integrated into the stonework, which will be visible against the limestone. A variety of indicia can be incorporated into the waterfall in this manner. The indicia can be in the form of letters or numbers or symbols. The indicia can create, for example, the street number of a house or building, or the letters of a business's or individual's initials or name.

It is a further object of the invention to provide a plaque integrated into the waterfall. The plaque can be made from a variety of different materials. The plaque can contain any variety of written or symbolic information, such as the street name and number for a house, or the name of a family. It could also contain a variety of honoraria, or memorial information. In the most preferred embodiment the plaque would be made of stone material into which words or symbols are carved or etched. This plaque would be integrated into the waterfall in a manner familiar in the stone masonry arts.

It is a further object of the invention to provide a decorative fountain and waterfall that provides the soothing sounds of flowing water. In one embodiment this is produced by the flow of water down the rock face surface of the waterfall. In alternate embodiments this is produced by a fountain at the top of the waterfall. In one embodiment of the invention water will fill a recess at the top of the waterfall, and water will flow naturally down the sides, or a single side, of the waterfall, thus producing the trickling sounds of water. In alternate embodiments of the invention there will be a small fountain at the top of the waterfall. This fountain will provide a decorative spray of water, and will add the feature of the sound of spraying water to the waterfall.

It is a further object of this invention to provide a decorative fountain and waterfall containing an integrated planter placed within the pedestal comprising the main portion of the waterfall. This combines the features of the waterfall described herein with the decorative features of house plants. In this configuration, water is supplied directly to the walls of the waterfall.

These and other aspects, features and advantages of the present invention will become apparent from the following detailed description taken in conjunction with the accompanying drawings.

### BRIEF DESCRIPTION OF THE SEVERAL VIEWS OF THE DRAWINGS

FIG. 1 is a perspective view of the decorative fountain and waterfall.

FIG. 2 is a cut away view of the interior of the waterfall

FIG. 3 is a perspective view of the decorative fountain and waterfall, showing the additional features of the indicia and the plaque.

FIG. 4 is a perspective view of waterfall containing the integrated planter.

FIG. 5 is a cut away view of the waterfall with integrated planter, showing the water distribution mechanisms for this embodiment of the invention.

### DETAILED DESCRIPTION OF THE INVENTION

Detailed embodiments of the present invention are disclosed herein. It is to be understood, however, that the disclosed embodiments are merely exemplary of the invention and that the invention may be embodied in various and alternative forms. Therefore, specified structural and functional details disclosed herein are not to be interpreted as limitations, but merely as a basis for the claims and as a representative basis for teaching one skilled in the art to variously employ the present invention.

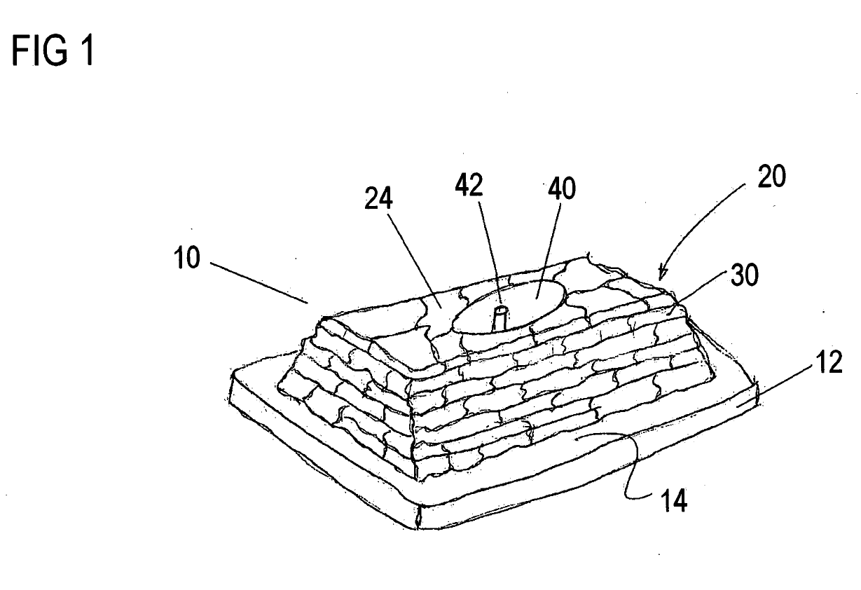

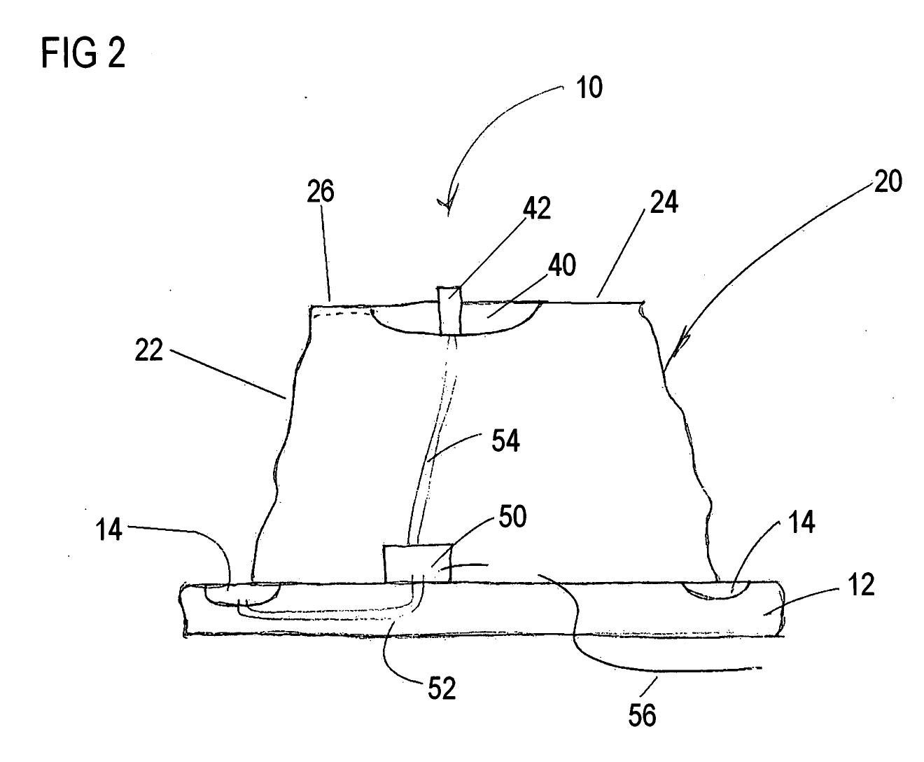

Referring now in more detail to the drawings, FIGS. 1, 2 & 3. FIG. 1 shows the waterfall 10 which is comprised of a base 12 and a pedestal 20. In the preferred embodiment, the pedestal 20 is constructed from a multiplicity of blocks 30. In the preferred embodiment the multiplicity of blocks 30 are made of natural stone. In the most preferred embodiment, the multiplicity of blocks 30 are small flat pieces of limestone. In alternate embodiments, the multiplicity of blocks 30 can be made of virtually any other type of stone, although stone that naturally occurs in flat sheets, such as slate, limestone or sandstone, will work best. It is also within the conception of the invention to cut stone from the types of stone that does not come naturally in flat sheets, such as marble or granite, to make the multiplicity of blocks 30. In other embodiments of the invention, the multiplicity of blocks 30 can be made of synthetic stone or made from a variety of synthetic materials such as plastics, polymers, resins or composite material. It is also within the conception of the invention to make the multiplicity of blocks 30 from stone aggregates such as concrete. Making the multiplicity of blocks 30 from such aggregates would allow the addition of color to some or all of the blocks 30.

In the most preferred embodiment, the multiplicity of blocks 30 are substantially flat. In the most preferred embodiment, the multiplicity of blocks 30 are made from small flat pieces of limestone measuring approximately one inch thick, and approximately four inches by six inches. The multiplicity of blocks 30 will generally not be of uniform size or shape. This lack of uniformity will give the pedestal 20 the look of a naturally occurring rock formation. The multiplicity of blocks 30 are connected to one another by any conventional grout or adhesive means well known in the stone and masonry arts. In a preferred embodiment, the multiplicity of blocks 30 are connected by means of conventional mortar made of sand and Portland cement.

In one embodiment of the invention, as depicted in FIG. 1, the pedestal 20 is substantially a pyramid with a relatively flat top surface. In alternate embodiments, the pedestal 20 could be virtually any three dimensional shape, whether conic, cylindrical, block-like, or ramshackled. In the preferred embodiment of the invention the pedestal 20 is approximately twelve inches in height and approximately twelve inches wide and twelve inches deep where it connects to the base 12, and because it bevels upward, the top 24 of the pedestal is approximately ten inches wide by ten inches deep. This size pedestal 20 in conjunction with the size of the blocks 30 described above, gives the waterfall 10 the appearance of a miniature natural waterfall. In many natural waterfalls, particularly those found in areas where the subsurface of the ground consists of limestone, natural waterfalls are often many feet wide and many feet high. The blocks 30 of the disclosed waterfall 10 are sized to have approximately the same relationship to the overall size of the pedestal 20 as the stones in a natural waterfall have to the overall size of the natural waterfall.

There is a recess 40 in the top 24 of the pedestal 20. The recess 40 can be made through the configuration of the blocks 30, can be cut into a single block, or can be formed by concrete or other suitable construction materials.

In at least one embodiment, there is a flow-way 26 constructed in the top 24 of the pedestal 20. The flow-way 26 connects to the recess 40. In the preferred embodiment the recess 40 is in a non-uniform configuration, giving the appearance of a small natural pool. In this configuration, the flow-way 26 appears as a small stream, which channels water from the small natural pool created by the recess 40 to the top of the waterfall side 22 of the waterfall 10.

The pedestal 20 sets on, and is connected to, a base 12. The base 12 can be made of any variety of sturdy material, but in the preferred embodiment the base 12 is a single piece of limestone. In alternate embodiments, the base 12 can be cast out of concrete. There is a catch basin 14 integral to the base 12 at the bottom of the waterfall side 22 of the pedestal 20.

In one embodiment of the invention, as shown in FIG. 2, at least one side of the pedestal 20 is the waterfall side 22. In this embodiment, the flow-way 26 is at the top of the waterfall side 22 of the pedestal, and the catch basin 14 is at the bottom.

In the most preferred embodiment, there is no flow-way 26, and the water from the recess 40 can flow naturally out of the recess 40 and down the waterfall 10 in any direction. In this configuration the catch basin 14 consists of a groove or indent that runs along the entire perimeter of the bottom of the pedestal 20 where it intersects the base 12. In this configuration, as depicted in FIG. 2, the catch basin 14 runs along the entire perimeter of the pedestal 20, which in the embodiment depicted in FIG. 2 is the entire length and width of the pedestal 20. Also in this configuration there will be one portion of the catch basin 14 that is lower than the rest of the catch basin 14 to allow water to flow to that area.

As depicted in FIG. 2, inside the pedestal 20, there is a pump 50 to move the water from the catch basin 14 at the bottom of the pedestal 20 to the recess 40 at the top 24 of the pedestal. This is accomplished by means of an intake tube 52 that runs from the catch basin 14 to the pump 50, and a delivery tube 54 that runs from the pump 50 to the recess 40. The intake tube 52, pump 50 and delivery tube 54 are in physical and hydrological connection. The pump 50 will be at any suitable location within the pedestal 20. The pump 50 can be any type of small pump well known in the art. In one embodiment the pump 50 will have a power cord 56 for connection to a source of electricity such as a battery or household A/C power. There will also be a switch (not shown), electrically connected to the pump 50, and located either on the power cord 56 or on a suitable location of the pedestal 20 or the base 12.

In operation, water is place in the recess 40 at the top 24 of the pedestal, and in the catch basin 14 on the base 12. Once water is in both the catch basin 14 and the recess 40, the pump is turned on, forcing water from the catch basin 14 into the recess 40. As the water fills the recess 40 it will begin to overflow from the recess 40 and onto the top 24 and out to the sides of the pedestal 20, and flow down the walls. This will produce the visual effect of a waterfall, as well as create the sound of flowing and trickling water.

In one embodiment, the water flowing out of the recess 40 will flow into the flow-way 26, and over the waterfall side 22 of the pedestal 20, creating a miniature waterfall. In alternate embodiments of the invention, a conventional flow control valve (not shown) can be added to the delivery tube 54, allowing the user to adjust the rate of flow of the water.

In alternate embodiments a small fountain 42 is hydraulically connected at the end of the delivery tube 54 and in the recess 40, at the top 24 of the waterfall 10. As is well known in the art, the fountain will restrict the flow of water from the delivery tube 54 creating pressure and spraying the water out of the fountain 42. This will create a decorative spray of water at the top of the waterfall 10, and will also enhance the sound of flowing water by creating the sound of water splashing into the recess 40.

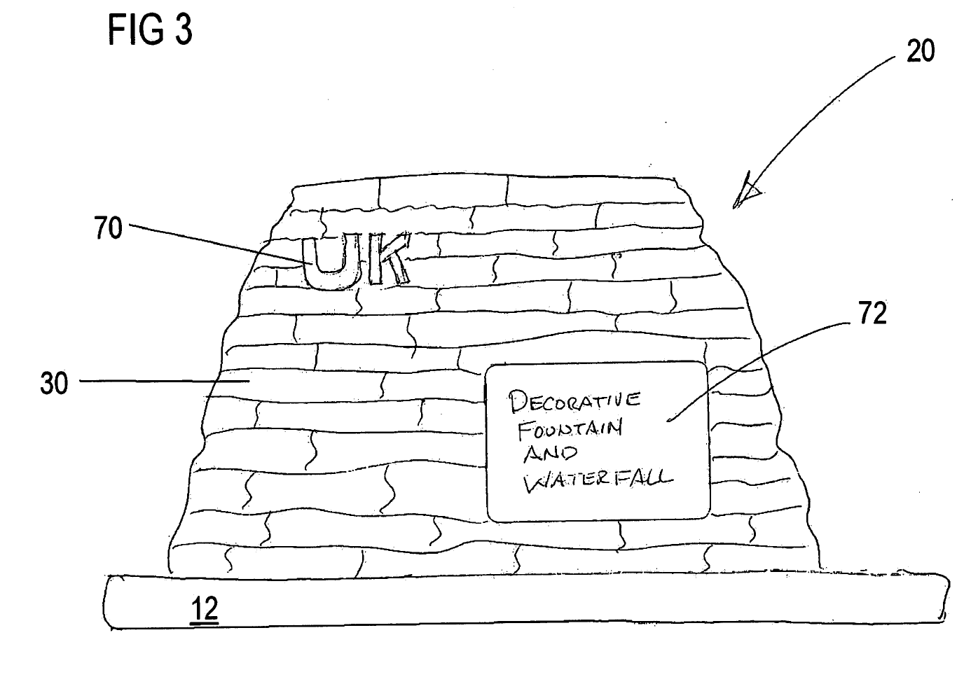

FIG. 3 depicts additional decorative features of the present invention. In alternate embodiments of the invention, indicia 70 may be provided. Indicia 70 is created by incorporating contrasting color stone or other material into the multiplicity of blocks 30 of the pedestal 20. The incorporation of such shapes into rock-work is well known in the stone working and masonry arts. Indicia 70 can be in the form of letters, numbers, shapes or symbols. In the representative example depicted in FIG. 3, the indicia 70 are the letters “U” and “K” which is the abbreviation for the University of Kentucky. As can be appreciated, indicia can be in a variety of different numbers and letters, and can represent a variety of different things, from the street number of a house or building to a person's initials, to the name of a company such as “IBM”.

FIG. 3 further depicts a plaque 72 incorporated into the pedestal 20 of the waterfall 10. The incorporation of such a plaque into rock-work is well known in the stone working and masonry arts. The plaque 72 can be made from any type of suitably strong and sturdy material. In one embodiment it can be a single piece of stone. In alternate embodiments it can be a piece of concrete, ceramic, tile, metals or plastics. Words and phrases can be carved, etched or embossed on the plaque 72. The representative depiction of the plaque 72 in FIG. 3 is the title of this invention, but other examples can include, but are no way limited to, the name and address of the occupants of a house, honoraria for a retiree or graduate, or memorial for a departed loved one.

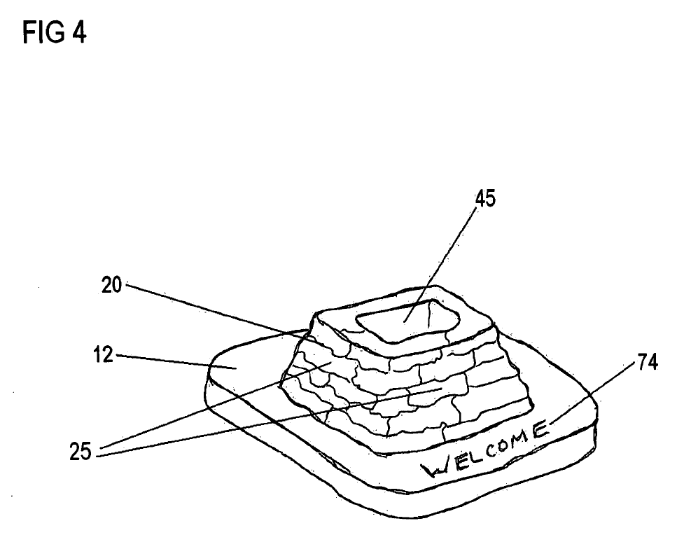

FIGS. 4 & 5 depicts an alternate embodiment of the invention containing an integrated planter. In this embodiment the planter 45 is built into the pedestal 20 of the waterfall 10. The planter 45 is defined by an interior space within the pedestal 20. The planter 45 can be constructed in a variety of conventional means, including by means of constructing the blocks 30 that comprise the pedestal 20 to leave an interior space therein which forms the planter 45. In an alternate embodiment, the planter 45 can be constructed by means of concrete poured into a mold to create the recess which forms the planter 45, with the blocks 30 that form the pedestal 20 built around this poured concrete. In yet another embodiment, the planter 45 can be formed by means of a conventional flower pot, with the blocks 30 that form the pedestal 20 built around the flower pot.

FIG. 4 also depicts an embodiment of the invention with a message 74 incorporated into the base 12. The message 74 can be any combination of words or symbols, and can be etched, carved, or engraved into the base 12. The message 74 depicted in FIG. 4 is “Welcome” and in this configuration the waterfall 10 with integrated planter 45 can be placed near the entrance way of a home. In the preferred embodiment the message 74 would be a street address with the name of the home owner, but any combination of words, letters, numbers and symbols is possible.

The exterior surfaces of the blocks 30 of the pedestal 20 form a multiplicity of faces 25. Each side of the pedestal 20 has a face 25. In the embodiment depicted in FIG. 4, the pedestal 20 is substantially pyramid shaped, with four sides, and therefore four faces 25. In other configurations, for example if the pedestal is essentially cylindrical in shape, there will be one continuous face 25 around the entire exterior surface of the pedestal 20. In other embodiments, the pedestal 20 can be constructed in an uneven or ramshackled manner, creating a variety of uneven and varying shaped faces 25.

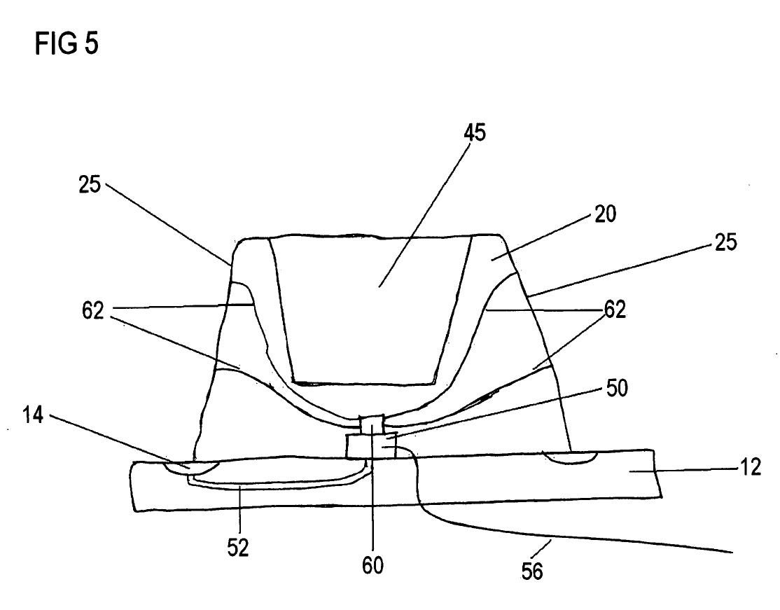

FIG. 5 shows the water distribution system for the alternate embodiment of the invention incorporating the planter 45. This system includes at least one intake tube 52 to draw water from the catch basin 14 into the pump 50. The pump 50 supplies water to the water distributor 60, which distributes water evenly into the distribution tubing 62. The distribution tubing 62 distributes water to the face 25 of the waterfall 10. The distribution tubing 62 terminates in the spaces between the blocks 30 of the pedestal. There are numerous distribution tubing 62 which are routed through the blocks 30 and which distribute water to various places on every face 25 of the waterfall 10.

In the most preferred embodiment of the waterfall 10 with integrated planter 45, water will be distributed and flow down every face 25 of the waterfall 10. The embodiment depicted in FIG. 4 is a four sided pyramid, but the waterfall 10 can be in virtually any shape or configuration, from a single face 25 cylindrical shape to a three sided triangular shape to a non-uniform ramshackled shape. Regardless of the shape of the pedestal 20, the water distribution system with distribution tubing 62 provides water to every face 25.

The planter 45 is essentially waterproof, and is separated from the water distribution system. The distribution tubing 62 always distributes water to face 25 of pedestal 20 and never to the top 24. This prevents water from potentially flowing into and potentially flooding the planter 45.

Distribution tubing 62 will run between the blocks 30 and through the grout or other connecting material between the blocks 30 to the face 25 of the waterfall 10. The distribution tubing will otherwise run behind the blocks 30 to the water distributor 60. In those embodiments where the planter 45 is made from concrete, it is possible to incorporate the distribution tubing 62 into the concrete that forms the planter 45.

In the preferred embodiment, the intake tube 52 is conventional half inch tubing, which can be made of any conventional tubing material, including but not limited to, plastic, PVC, rubber or metal. The distribution tubing 62 will be made from standard small bore conventional tubing, typically one quarter or one eighth inch tubing, made from any conventional tubing material, including but not limited to rubber, plastic, PVC or metals. Other slightly larger or slightly smaller tubing can be used for either the intake tube 52 or distribution tubing 62 depending upon the size and configuration of the system.

The distribution tubing 62 will supply the water to the face 25 of the waterfall 10, to give the appearance of water bubbling from the rock of a waterfall. Just as the configuration of the waterfall with the water flowing across the top gives the appearance of a miniature waterfall, in this configuration there is the appearance of a miniature spring with water flowing from the rock.

Flowers or living plants (not shown) may be placed in the planter 45. In the preferred embodiment, the configuration of the waterfall 10 in conjunction with the plants in the planter 45 are primarily for decorative purposes. This will combine the decorative and esthetic features of the waterfall 10 as described herein with the decorative and esthetic features of living plants, which are one of the most common indoor decorative features. When used in-doors, as contemplated in at least one of the disclosed embodiments, the planter 45 can hold any type of in-door plant. In at least one embodiment, and with some types of plants, the water can provide moisture for the plants. This is particularly true for hanging type plants such as philodendron, bleeding heart, and a variety of ferns.

The waterfall 10 with integrated planter 45 can also include the indicia 70 and plaque 72 as disclosed herein.

In operation, water is placed in the catch basin 14, and the pump 50 is activated. The pump 50 draws water from the catch basin 14 by means of the intake tube 52, and then pumps this water into the water distributor 60, which evenly distributes water into each of the distribution tubing 62. Water flows down the multiplicity of faces 25 and into the catch basin 14, where it is then sucked back into the system by means of the intake tube 52 and pump 50.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only, and are not exhaustive of the scope of the invention. Consequently, the present invention is intended to be limited only be the spirit and scope of the claims, giving full cognizance to equivalents in all respects.

I claim:

1. A waterfall with integrated planter comprising:
a pedestal with a planter integrated within said pedestal;
said pedestal having at least one face;
said pedestal setting on a base wherein said base includes a catch basin positioned where said pedestal adjoins said base;
means for removing water from said catch basin and distributing it to said at least one face; and
wherein water flows down said at least one face to create the appearance of a miniature natural waterfall.

2. The waterfall with integrated planter of claim 1, wherein said pedestal is constructed of a multiplicity of blocks.

3. The waterfall with integrated planter of claim 2, wherein said means for removing water from said catch basin and distributing in to said multiplicity of faces comprises:
an intake tube placed in said catch basin;
a pump connected to said intake tube which pumps water into a water distributor; and
a multiplicity of distribution tubing connected to said water distributor and supplying water to said multiplicity of faces through said blocks.

4. The waterfall with integrated planter of claim 1, further comprising indicia incorporated into said pedestal.

5. The waterfall with integrated planter of claim 1, further comprising a plaque incorporated into said pedestal.

6. The waterfall with integrated planter of claim 1, further comprising a message incorporated into said base.

7. A decorative waterfall with planter comprising:
a base;
a pedestal connected to said base;
said pedestal having a perimeter and at least one face;
a catch basin formed within said base, said catch basin located adjacent to said perimeter of said pedestal when said pedestal is connected to said base;
said pedestal containing an interior space that forms a planter integrated within said pedestal;
said pedestal made from a multiplicity of blocks;
a pump housed within said pedestal;
an intake tube running from said catch basin to said pump;
a water distributor connected to said pump;
a multiplicity of distribution tubing connected to said water distributor;
said multiplicity of distribution tubing running between said multiplicity of blocks to said at least one face; and
wherein water is placed in the catch basin and drawn into said pump through said intake tube, delivered to said multiplicity of distribution tubing through said water distributor, supplied to said at least one face through said multiplicity of distribution tubing; and allowed to flow down said at least one face an into said catch basin.

8. The decorative waterfall with planter of claim 7, further comprising indicia incorporated into said pedestal.

9. The decorative waterfall with planter of claim 7, further comprising a plaque incorporated into said pedestal.

10. The decorative waterfall with planter of claim 7, further comprising a message incorporated into said base.
